(19) United States
(12) Patent Application Publication
(10) Pub. No.: US 2012/0188584 A1
(43) Pub. Date: Jul. 26, 2012

(54) Document imaging node with internal web server execution environment

(76) Inventors: Swee Huat SNG, Torrance, CA (US); Joseph YANG, Cypress, CA (US)

(21) Appl. No.: 12/930,970

(22) Filed: Jan. 21, 2011

(51) Int. Cl. G06F 3/12

(52) U.S. Cl. 358/1.15

(57) ABSTRACT

An imaging node hosts a web server execution environment that exports document imaging services using server-side scripting. The web server execution environment receives Hypertext Transfer Protocol (HTTP) requests from a web browser and runs server-side scripts that resolve HTTP requests to native imaging services. A native imaging execution environment then executes the resolved native imaging services. Moreover, the web server execution environment can run server-side scripts that resolve HTTP requests to non-native imaging services and invoke the resolved non-native imaging services remotely as required.

### BACKGROUND OF THE INVENTION

The present invention relates to document imaging services and, more particularly, to methods and systems for invoking document imaging services.

Document imaging services are operations that manipulate documents through imaging. Document imaging services are often provided by imaging nodes, such as printers, scanners, copiers and multifunction peripherals (MFPs), that are invoked by user interfaces. When considering the document imaging services provided by an imaging node, those services performed on the imaging node itself are sometimes called “native” imaging services. Native imaging services generally include, for example, generating printouts from electronic image files (printing) and generating electronic image files from printouts (scanning). On the other hand, those services performed on external nodes invoked by the imaging node are sometimes called “non-native” imaging services.

Conventionally, imaging node manufacturers have developed their own proprietary protocols for invoking document imaging services on their imaging nodes.

More recently, a standard web services protocol called Devices Profile for Web Services (DPWS) using Web Services Discovery (WS-Discovery), Web Services Print (WS-Print) and Web Services Scan (WS-Scan) has been developed in an attempt to address shortcomings of proprietary protocols. This standard protocol for discovering and invoking document imaging services uses Simple Object Access Protocol (SOAP) methods to carry requests and responses between a compliant sender and receiver. While this standard protocol allows a user interface to invoke document imaging services on imaging nodes made by varied manufacturers, the user interface and imaging node must still be made standard-compliant (e.g., a SOAP stack is required), and only those services that are explicitly supported in the standard are made accessible.

It is also known to deploy document imaging applications on a standalone web server node and invoke these applications from a web browser installed on an imaging node. In these deployments, the applications invoked by the web browser access native imaging services on the imaging node that are needed to deliver requested application functionality using SOAP methods, in a manner similar to DPWS. While these deployments allow native imaging services to be invoked from a web browser, an external web server node is required to mediate between the web browser and the native imaging services using SOAP.

### SUMMARY OF THE INVENTION

The present invention provides an imaging node that hosts a web server execution environment that exports document imaging services using server-side scripting. The web server execution environment receives Hypertext Transfer Protocol (HTTP) requests from a web browser and runs server-side scripts that resolve HTTP requests to native imaging services. A native imaging execution environment then executes the resolved native imaging services. Moreover, the web server execution environment can run server-side scripts that resolve HTTP requests to non-native imaging services and invoke the resolved non-native imaging services remotely as required. Collocating a web server execution environment with a native imaging execution environment on an imaging node has several advantages, among them: (1) allowing requests for document imaging services to be initiated from any standard web browser; (2) enabling standard web browser technologies to be used in support of request/response flows [e.g., Secure Socket Layer/Transport Layer Security (SSL/TLS) for data privacy, cookies for session support, Hypertext Markup Language (HTML) forms for data submission, HTML frames for presenting data from disparate sources, Document Object Model (DOM) for dynamic data presentation, JavaScript Object Notation (JSON) for simple object representation, Asynchronous JavaScript and Extensible Markup Language (AJAX) for minimizing web page interference while retrieving data, etc.]; (3) allowing native imaging services to be invoked without reliance on proprietary protocols or web services protocols (e.g., DPWS, SOAP); and (4) allowing native imaging services to be invoked without reliance on an intermediary node (e.g., external web server node) to mediate between the user interface and the imaging services.

In one aspect of the invention, an imaging node comprises a native imaging execution environment and a web server execution environment operatively coupled with the native imaging execution environment, wherein an HTTP request is received by the web server execution environment from a web browser and resolved within the web server execution environment to a native document imaging service, and wherein the native document imaging service is executed within the native imaging execution environment.

In some embodiments, the native document imaging service is resolved at least in part by executing a server-side script identified in the HTTP request.

In some embodiments, the native document imaging service is resolved at least in part by mapping a server-side scripting function called by the server-side script to the native document imaging service.

In some embodiments, the HTTP request is further resolved within the web server execution environment to a non-native document imaging service, and wherein the non-native document imaging service is remotely invoked by the web server execution environment.

In some embodiments, the web services execution environment transmits an HTTP response to the web browser.

In some embodiments, the HTTP request is generated by the web browser in response to a command inputted by a user.

In some embodiments, the native document imaging service is a print service.

In some embodiments, the native document imaging service is a scan service.

In some embodiments, the native document imaging service is a copy service. In some embodiments, the native document imaging service is a fax service.

In some embodiments, the native document imaging service is an email, File Transfer Protocol (FTP) or HTTP document transfer service.

In some embodiments, the native document imaging service is an imaging node status monitoring service.

In some embodiments, the web browser is internal to the imaging node.

In some embodiments, the web browser is external to the imaging node.

In another aspect of the invention, a method for facilitating provisioning of document imaging services comprises the steps of resolving by an imaging node an HTTP request from a web browser to a native document imaging service using server-side scripting; and executing on the imaging node the native document imaging service.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a document imaging system in some embodiments of the invention.

FIG. 2 shows an imaging node in some embodiments of the invention.

FIG. 3 shows elements of the document imaging system of FIG. 1 in more detail.

FIG. 4 shows a method for facilitating provisioning of document imaging services in some embodiments of the invention.

### DETAILED DESCRIPTION OF A PREFERRED EMBODIMENT

FIG. 1 shows a document imaging system 100 in some embodiments of the invention. Document imaging system 100 includes an imaging node 200 hosting a native imaging execution environment (NIEE) 120 and a web server execution environment (WSEE) 130 that are communicatively coupled. WSEE 130 is also communicatively coupled with web client elements (WCE) 110 and non-native document imaging services 140. WCE 110 transmits HTTP requests for document imaging services and receives HTTP responses to these requests. Imaging node 200 fulfills HTTP requests, which results in provision of requested document imaging services. WCE 110 may be located either external or internal to imaging node 200.

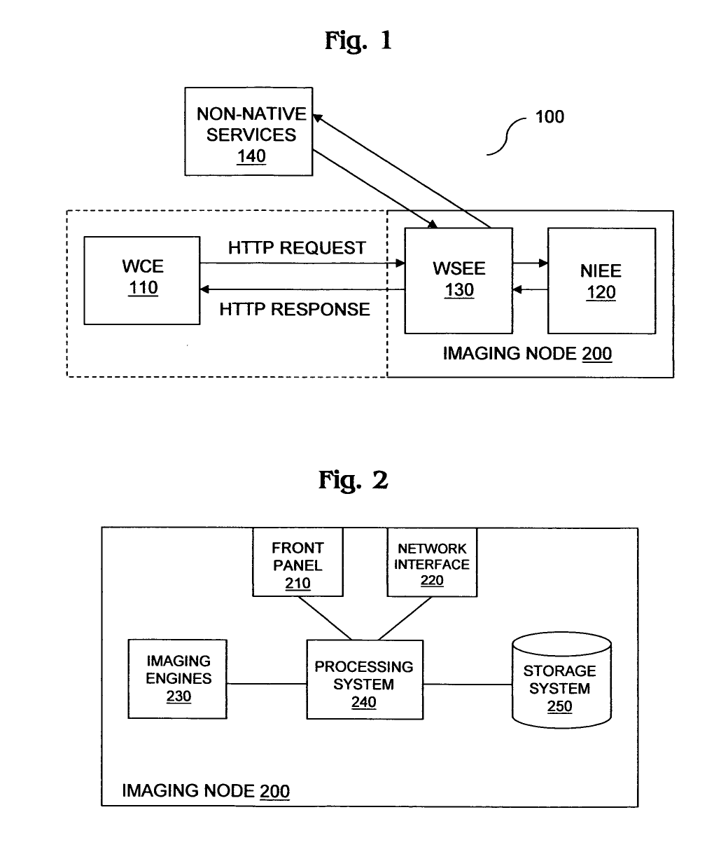

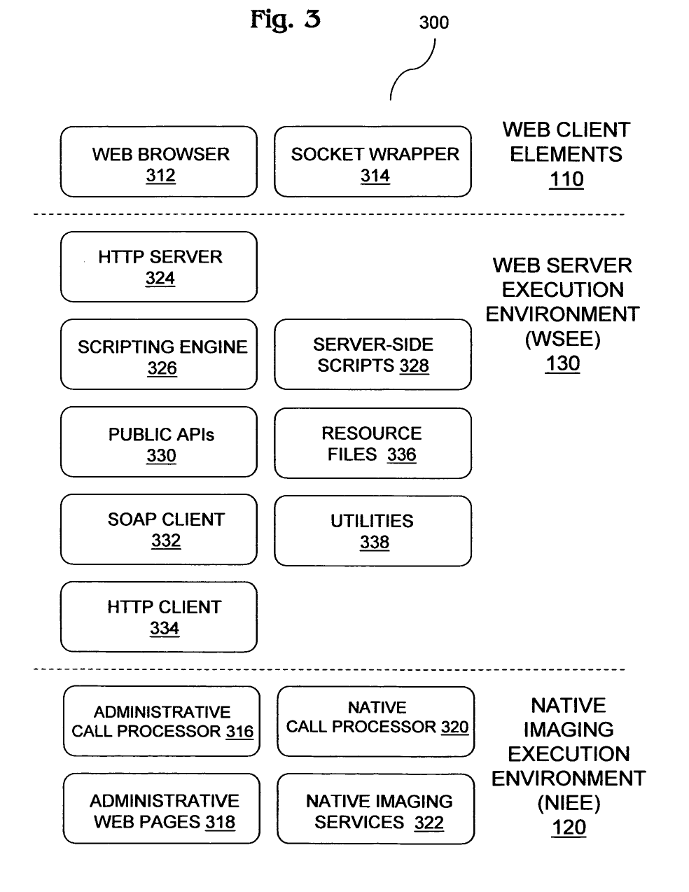

FIG. 2 shows imaging node 200 in more detail. Imaging node 200 has a front panel 210, a network interface 220, imaging engines 230 and a storage system 250, all of which are communicatively coupled with a processing system 240 that may include one or more processors. Elements of NIEE 120 and WSEE 130 reside on and interact with various components 210, 220, 230, 250 of imaging node 200, under the control of processing system 240, to fulfill HTTP requests and provide requested document imaging services.

Turning now to FIG. 3, elements of WCE 110, NIEE 120 and WSEE 130 are shown in more detail. WCE 110 includes a web browser 312 and a socket wrapper 314. Web browser 312 renders web pages on a display screen, such as a liquid crystal display (LCD) or light emitting diode (LED) touch screen on front panel 210 of imaging node 200 or on a personal computer monitor external to imaging node 200. Web browser 312 accepts inputs from a user of imaging node 200 and displays outputs to a user of imaging node 200 via web pages. More particularly, web browser 312 generates and transmits HTTP requests for document imaging services in response to user inputs inputted into web pages rendered on a display screen and receives HTTP responses to those requests and outputs them to the user on rendered web pages. Web browser 312 invokes standard web browser technologies, such as SSL/TLS, cookies, HTML forms, HTML frames, DOM and JSON, in support of HTTP request/response flows. For example, web pages may present standard HTML widgets like checkboxes, input text fields, radio buttons and dropdown lists to facilitate user input. Web browser 312 reads and writes network data through socket wrapper 314. In some embodiments, web browser 312 and socket wrapper 314 are internal to imaging node 200 and are installed in storage system 250 and executed by processing system 240. In other embodiments, web browser 312 and socket wrapper 314 are external to imaging node 200 and are executed by an external processing system.

NIEE 120, which is internal to imaging node 200, includes an administrative call processor 316, administrative web pages 318, a native call processor 320 and native imaging services 322. Administrative call processor 316 fulfills HTTP requests received from web browser 312 addressed to an administrative endpoint Uniform Resource Locator (URL) by returning administrative web pages 318 read from storage system 250. Administrative call processor 316 is installed in storage system 250 and executed by processing system 240, and administrative web pages 318 are stored in storage system 250.

Native call processor 320 fulfills HTTP requests received from web browser 312 that are addressed to a document imaging endpoint URL by invoking WSEE 130 to run server-side scripts that resolve HTTP requests to native imaging services 322. Native call processor 320 is notified by WSEE 130 of resolved native imaging services 322 and calls resolved native imaging services 322, causing them to execute. Native call processor 320 is installed in storage system 250 and executed by processing system 240. Native imaging services 322 may include, by way of example, print, scan, copy, fax, document transfer (e.g., by email, FTP, HTTP) and/or image node status monitoring. Some of native imaging services 322 (e.g., print, scan, copy, fax) are executed at least in part by imaging engines 230 under the control of processing system 240.

WSEE 130, which is also internal to imaging node 200, includes an HTTP server 324, a scripting engine 326, server-side scripts 328, public application programming interfaces (APIs) 330, a SOAP client 332, an HTTP client 334, resource files 336 and utilities 338. In some embodiments, server-side scripts 328 and resource files 336 are downloaded via network interface 220 as a single application file package that is installed on imaging node 200 under the control of processing system 240.

HTTP server 324 generates and transmits HTTP responses to HTTP requests for document imaging services made by web browser 312. HTTP server 324 invokes standard web technologies, such as SSL/TLS, cookies, HTML forms, HTML frames, DOM and JSON, in support of HTTP request/response flows. HTTP server 324 is installed in storage system 250 and executed by processing system 240.

Scripting engine 326 executes server-side scripts 328 for document imaging services identified in HTTP requests received from web browser 312. Scripting engine 326 is installed in storage system 250 and executed by processing system 240.

Server-side scripts 328 are executables, such as Embedded Server Pages (ESP) and/or Embedded JavaScript (EJS) pages, that are stored in storage system 250 and executed by scripting engine 326. Server-side scripts that address native imaging services, when executed, call server-side scripting functions that public APIs 330 map to native imaging services 322. Server-side scripts that address non-native imaging services 140, when executed, instruct SOAP client 332 and/or HTTP client 334 to invoke non-native imaging services 140 by generating and transmitting external requests. Server-side scripts 328 are stored in storage system 250.

Public APIs 330 map server-side scripting functions called by server-side scripts 328 to native imaging services 322 and instruct native call processor 320 to invoke the resolved native imaging services 322. Public APIs 330 are installed in storage system 250 and executed by processing system 240.

SOAP client 332 remotely invokes non-native imaging services 140 via network interface 220 using SOAP methods. SOAP client 332 remotely invokes non-native imaging services 140 in response to instructions received from server-side scripts 328. SOAP client 332 is installed in storage system 250 and executed by processing system 240.

HTTP client 334 remotely invokes via network interface 220 non-native imaging services 140 using HTTP requests. HTTP client 334 remotely invokes non-native imaging services 140 in response to instructions received from server-side scripts 328. HTTP client 334 is installed in storage system 250 and executed by processing system 240.

Resource files 336 are web resource files, such as custom data files and image files, that may be referenced by HTTP server 324 or scripting engine 326 when formulating HTTP requests and HTTP responses. Resource file types include, for example, Cascading Style Sheets (CSS), Graphics Interchange Format (GIF), HTML, Joint Photographic Experts Group (JPG), JSON, Portable Network Graphics (PNG), text (TXT) and Extensible Markup Language (XML). Resource files 336 are stored in storage system 250.

Utilities 338 perform specialized data manipulation operations and may be invoked by HTTP server 324 or scripting engine 326 when formulating HTTP requests and responses as well as for other purposes. By way of example, utilities 338 may include OpenSSL, invoked to provide encryption/decryption and cryptographic functions; IJG JPEG 6-b, invoked to manipulate JPG files to reduce the size of scan images generated by imaging node 200 and allow thumbnail images to be created from full-size scan images; Unzip-5.52, invoked to install application packages that received in the ZIP file format; and FTP Client Loopback, which emulates FTP transfers to store scan images to storage system 250 in the absence of an FTP server.

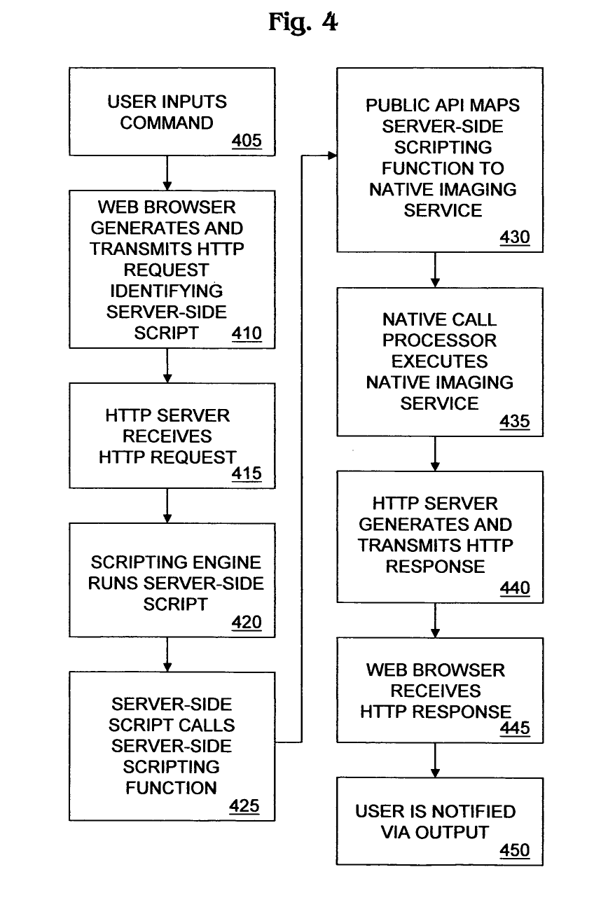

FIG. 4 shows a method for facilitating provisioning of document imaging services in some embodiments of the invention. In Step 405, a user inputs a command. Consider an example where web browser 312 is internal to imaging node 200 and the user wishes to have a document scanned by imaging node 200. In that event, the user inputs a command by pressing a “scan” button on a web page rendered on a touch screen of front panel 210.

In Step 410, the web browser generates and transmits an HTTP request identifying a server-side script corresponding to the command. For example, web browser 312 generates and transmits an HTTP request indicating to fetch a server-side script named scan.esp (assuming the scripting language is ESP) which is included among server-side scripts 328 stored in storage system 250.

In Step 415, an HTTP server on an imaging node receives the HTTP request. For example, the HTTP request transmitted by web browser 312 specifies an address of a document imaging endpoint URL, which results in native call processor 320 relaying the HTTP request to HTTP server 324.

In Step 420, a scripting engine on the imaging node runs the server-side script. For example, HTTP server 324 invokes scripting engine 326, which executes the server-side script scan.esp identified in the HTTP request.

In Step 425, the server-side script calls a server-side scripting function on the imaging node. For example, the server-side script scan.esp, when executed, calls a server-side scripting function server_scan( ).

In Step 430, a public API on the imaging node maps the server-side scripting function to a native imaging service. For example, one of public APIs 330 that is responsible for exporting native scanning operations maps the server-side scripting function to a native function named scan( ).

In Step 435, a native call processor on the imaging node executes the native imaging service. For example, the one of public APIs 330 that is responsible for exporting native scanning operations calls scan( ) which causes native call processor 320 to execute a scanning operation on imaging node 200 using imaging engines 230.

In Step 440, the HTTP server generates and transmits an HTTP response to the web browser. For example, HTTP server 324 generates and transmits an HTTP response to web browser 312 in the form of a status web page indicating that the requested scanning operation has been successfully completed.

In Step 445, the web browser receives the HTTP response, and in Step 450 the user is notified via output. For example, web browser 312 renders the status web page from the HTTP response on the touch screen of front panel 210.

The above example illustrates how within document imaging system 100, through the expedient of internal web server execution environment 130, web browser 312 can initiate a basic scanning operation on an imaging node 200 using HTTP and standard web technologies. Document imaging system 100, however, also permits a web browser 312 to initiate using HTTP and standard web technologies more complex operations and workflows that may involve native imaging services 322, or a hybrid of native imaging services 322 and non-native imaging services 140 (wherein SOAP client 332 and/or HTTP client 334 invoke non-native imaging services 140). Purely by way of example, document imaging system 100 enables web browser 312 to initiate the following operations and workflows: scanning to Google Docs; printing from Google Docs; scanning to Zoho; printing from Zoho; printing from Google Maps; scanning and previewing thumbnails and printing selected pages; and remote device management.

It will therefore be appreciated by those of ordinary skill in the art that the invention can be embodied in other specific forms without departing from the spirit or essential character hereof. The present description is thus considered in all respects to be illustrative and not restrictive. The scope of the invention is indicated by the appended claims, and all changes that come with in the meaning and range of equivalents thereof are intended to be embraced therein.

What is claimed is:

1. An imaging node, comprising:
a native imaging execution environment; and
a web server execution environment operatively coupled with the native imaging execution environment, wherein a Hypertext Transfer Protocol (HTTP) request is received by the web server execution environment from a web browser and resolved within the web server execution environment to a native document imaging service, and wherein the native document imaging service is executed within the native imaging execution environment.

2. The imaging node of claim 1, wherein the native document imaging service is resolved at least in part by executing a server-side script identified in the HTTP request.

3. The imaging node of claim 2, wherein the native document imaging service is resolved at least in part by mapping a server-side scripting function called by the server-side script to the native document imaging service.

4. The imaging node of claim 1, wherein the HTTP request is further resolved within the web server execution environment to a non-native document imaging service, and wherein the non-native document imaging service is remotely invoked by the web server execution environment.

5. The imaging node of claim 1, wherein the web services execution environment transmits an HTTP response to the web browser.

6. The imaging node of claim 1, wherein the HTTP request is generated by the web browser in response to a command inputted by a user.

7. The imaging node of claim 1, wherein the native document imaging service is one of a print, scan, copy or fax service.

8. The imaging node of claim 1, wherein the native document imaging service is one of an email, File Transfer Protocol (FTP) or HTTP document transfer service.

9. The imaging node of claim 1, wherein the native document imaging service is an imaging node status monitoring service.

10. The imaging node of claim 1, wherein the web browser is internal to the imaging node.

11. A method for facilitating provisioning of document imaging services, comprising the steps of:
resolving on an imaging node an HTTP request from a web browser to a native document imaging service using server-side scripting; and
executing on the imaging node the native document imaging service.

12. The method of claim 11, wherein the resolving step comprises executing a server-side script identified in the HTTP request.

13. The method claim 12, wherein the resolving step further comprises mapping a server-side scripting function called by the server-side script to the native document imaging service.

14. The method of claim 11, further comprising the steps of:
resolving on the imaging node the HTTP request to a non-native document imaging service using server-side scripting; and
remotely invoking by the imaging node the non-native document imaging service.

15. The method of claim 11, further comprising the step of transmitting by the imaging node to the web browser an HTTP response.

16. The method of claim 11, wherein the HTTP request is generated by the web browser in response to a command inputted by a user.

17. The method of claim 11, wherein the native document imaging service is one of a print, scan, copy or fax service.

18. The method of claim 11, wherein the native document imaging service is one of an email, FTP or HTTP document transfer service.

19. The method of claim 11, wherein the native document imaging service is an imaging node status monitoring service.

20. The method of claim 11, wherein the web browser is internal to the imaging node.
